(19) United States
(12) Patent Application Publication
(10) Pub. No.: US 2015/0113840 A1
(43) Pub. Date: Apr. 30, 2015

(54) ELECTRIC FIREPLACE

(71) Applicant: FUJIAN ERLING ELECTRONICS CO., LTD., Zhangzhou City, Fujian (CN)

(72) Inventors: Jiacai Yang, Zhangzhou City (CN); Tabin Li, Zhangzhou City (CN)

(73) Assignee: FUJIAN ERLING ELECTRONICS CO., LTD., Zhangzhou City, Fujian (CN)

(21) Appl. No.: 14/403,721

(22) PCT Filed: Nov. 16, 2012
(86) PCT No.: PCT/CN2012/084743

§ 371 Date: Nov. 25, 2014

(30) Foreign Application Priority Data
Jul. 4, 2012 (CN) 201220321810.3

(51) Int. Cl. F21S 10/04; F24D 19/10

(52) U.S. Cl. CPC F21S 10/04; F24D 19/1096
USPC 40/428

(57) ABSTRACT

An electric fireplace, comprising a main body, a control panel, a control circuit and a driving mechanism; the main body includes a housing and a simulation device, the simulation device and the control circuit are disposed inside the housing, the simulation device, the control panel, the driving mechanism are respectively electrically connected to the control circuit; the control panel is pivot joint to an edge of the front wall of the housing; the driving mechanism is connected to the control panel to make the control panel with an unfold state and a fold state with respect to the main body, with a concealable control panel, the appearance of the electric fireplace is more like traditional firewood fireplace, and the consumers can get a better view of flame, the present invention is simple structural and easy to manufacture.

### FIELD OF THE INVENTION

The present invention present invention relates to an electric fireplace, especially to an electric fireplace with a concealable control panel.

### BACKGROUND OF THE INVENTION

With the updating of fireplace, electrical fireplaces with decorative function are selling well, high visual sense is requested. Existing electrical fireplaces are disposed with simulation charcoals, lights and fire simulation board connected to the circuit board inside the housing of the electric fireplace, a control panel is used to control the electric fireplace to work. However, this kind of electric fireplace still looks like electric apparatus, especially with the control panel. How to make it more like traditional fireplace is a big problem to resolve.

### SUMMARY OF THE INVENTION

The object of the present invention is to overcome the disadvantage of the existing technology and to provide with an electric fireplace, with a concealed control panel, the appearance of the electric fireplace looks more like the traditional fireplace, the assumers can get a better view of flame, and the structure is simple and easy to manufacture.

The technical proposal of the present invention to solve the technical problems is that:

An electric fireplace, comprising a main body, a control panel, a control circuit and a driving mechanism; the main body includes a housing and a simulation device, the simulation device and the control circuit are disposed inside the housing, the simulation device, the control panel, the driving mechanism are respectively electrically connected to the control circuit; the control panel is pivot joint to an edge of the front wall of the housing; the driving mechanism is connected to the control panel to make the control panel with an unfold state and a fold state with respect to the main body.

The driving mechanism includes a motor and a rotation shaft connected to the motor, the control panel is secured to the rotation shaft.

The control circuit includes a single chip and a control button, an output of the single chip is connected to the motor.

It further comprises a glass cover, the glass cover is covered on the front wall of the housing; the control panel is disposed with several touch switches.

The control panel further includes a displayer to indicate temperature, air pressure or time.

The driving mechanism further includes two limit switches, two limit switches are respectively disposed in the front side and the rear side of the control panel.

The housing further includes a baffle, the housing is divided into an upper components area and a lower fire simulation area, the simulation device is placed inside the fire simulation area, the single chip of the control circuit is assembled inside the upper components area or the simulation device.

Two assembly racks are disposed in both sides of the upper portion of the control panel, the assembly portion of the assembly rack is disposed on the bottom surface of the baffle; a groove is disposed at the center of the front of the baffle to assemble the control panel.

The advantages of the present invention are as following:

1. with the concealable control panel, the appearance of the electric fireplace is more like traditional firewood fireplace, and the consumers can get a better view of flame, and it is simple structural and easy to manufacture.

2. with the single chip connected to control the rotation speed and time of the motor.

3. with the touch switches, even the electric fireplace is disposed with a glass cover, it is still easy for a user to operate the control panel.

4. with the two limit switches, the control automation and the safety of the driving mechanism to the control panel are improved.

The present invention will be further described with the drawings and the embodiment, but an electric fireplace of the present invention is not limited to the embodiment.

### BRIEF DESCRIPTION OF THE DRAWINGS

The present invention will be further described with the drawings and the embodiments.

FIG. 1 illustrates a schematic diagram of the present invention with the control panel in open state.

FIG. 2 illustrates a schematic diagram of the present invention with the control panel in concealed state.

FIG. 3 illustrates a schematic diagram of the control panel of the present invention.

FIG. 4 illustrates a block diagram of control function of the present invention.

### DETAILED DESCRIPTION OF THE EMBODIMENTS

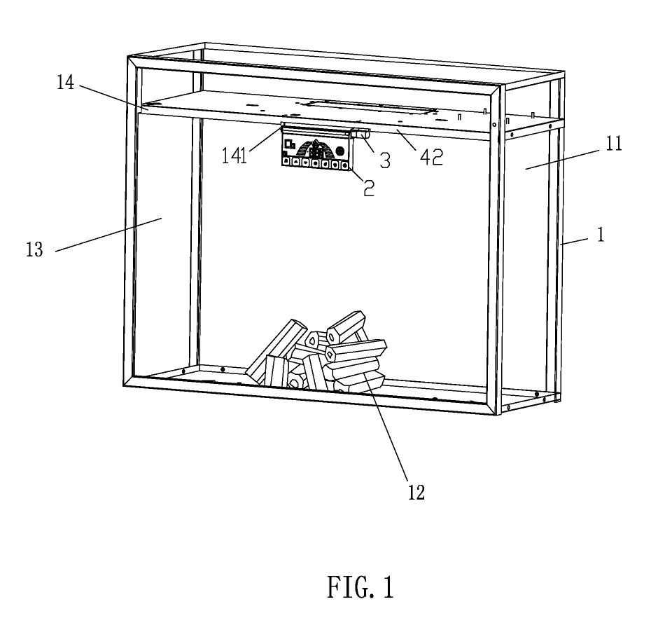

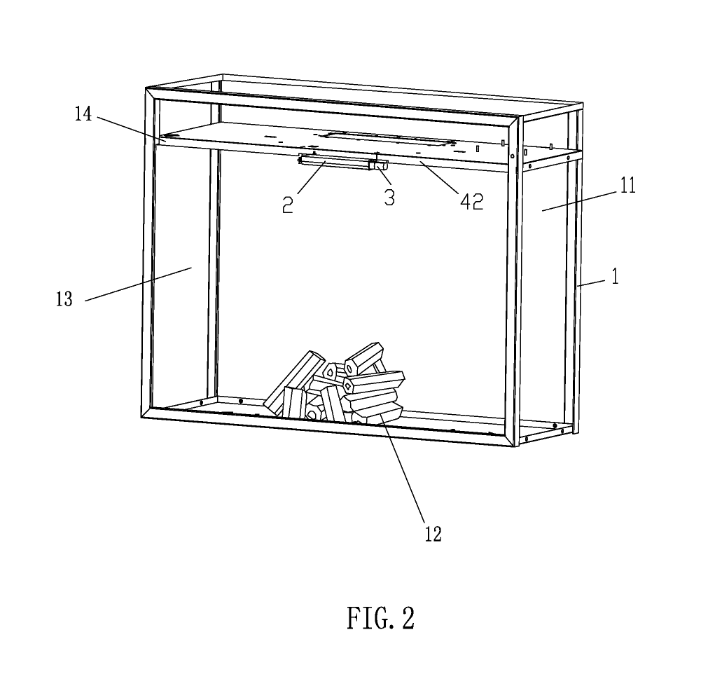

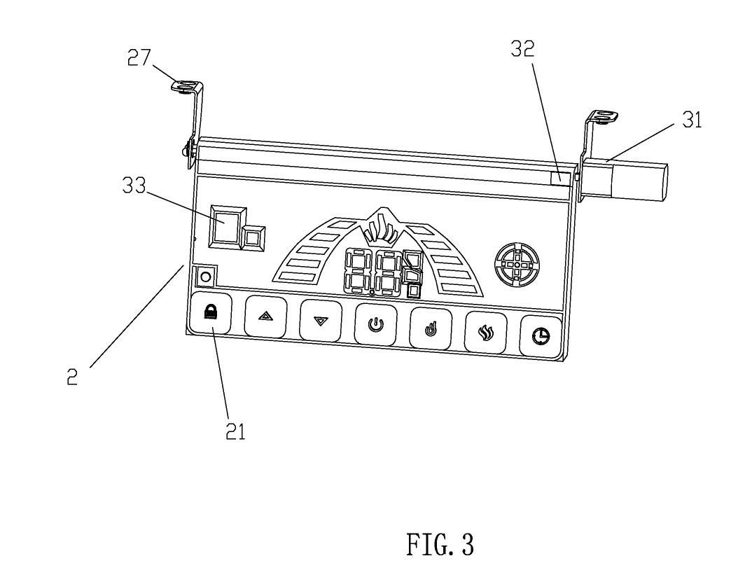

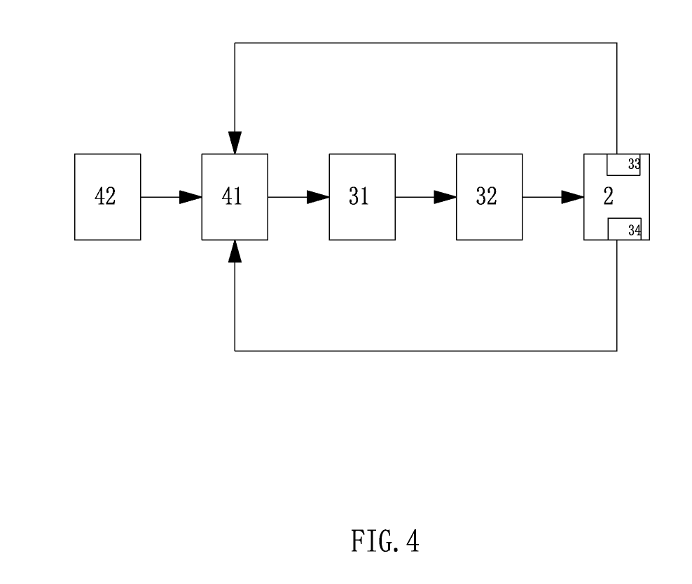

Please refer to FIG. 1, FIG. 2, FIG. 3 and FIG. 4, an electric fireplace of the present invention includes a main body 1, a control panel 2, a driving mechanism 3 and a control circuit 4. The main body 1 includes a housing 11 and a fire simulation device 12, the simulation device 12 and the control circuit 4 are disposed inside the housing 11; the control panel 2 is pivot joint to an edge of a front wall of the housing 11; the simulation device 12, the control panel 2 and the driving mechanism 3 are electrically connected to the control circuit 4.

The driving mechanism 3 comprises a reducer motor 31 and a rotation shaft 32 connected to the reducer motor 31, the control panel 2 is secured to the rotation shaft 32.

The control circuit 4 includes a single chip 42 and a control button 42, an output of the single chip 41 is connected to the reducer motor 31 to control the rotation speed and period of the reducer motor 31; the button 42 is connected to an input of the single chip 41 to control the single chip 41.

The housing 11 further comprises a baffle 14, so that the housing 11 is divided into an upper components area and a lower fire simulation area, the simulation device 12 is assembled in the lower fire simulation area, the single chip 41 of the control circuit 4 and the power supply is assembled inside the upper component area or inside the simulation device 12. The main body 1 further includes a glass cover 13, the glass cover 13 is covered on the front of the housing.

The control panel 2 is disposed with several touch switches 21, it further includes a displayer 22 to indicate temperature, time and flame type. Two assembly racks 23 are disposed at the upper side of the control board 2 in both sides, the assembly portion of the assembly rack 23 is disposed at the bottom surface of the baffle 14; a groove 141 is disposed at the center of the baffle 14, thus convenient to assemble the control board 2.

As the switches on the control board 2 are touch switches, even the main body 1 is assembled with the glass cover 13, a user can touch the touch switches through the glass cover 13 to control the electric fireplace to work.

To realize control automation of driving mechanism and the safety, the driving mechanism 3 further includes two limit switches 33, 34, two limit switches 33, 34 are respectively disposed in the front side and the rear side of the control panel 2.

When using, touching the touch switch 21 of the control panel 2 and choosing a proper temperature, time and flame type; pressing the control button 42, the single chip 41 controls the reducer motor 31 of the driving mechanism to rotate, then the rotation shaft 32 rotates to drive the control panel 2 to rotate, when the limit switch 33 in the rear side of the control panel 2 touches the interior wall of the housing 11, the reducer motor 31 stops rotating, the control panel 2 is retracted and concealed.

To regulate the temperature or flame type, repressing the control button 42, the single chip 41 controls the motor 31 of the driving mechanism to rotate, then the rotation shaft 32 rotates to drive the control panel 2 to rotate, when the limit switch 34 in the front side of the control panel 2 touches the interior wall of the glass cover 13, the motor 31 stops rotating, the control panel 2 is situated unfolded, the user can regulate the temperature or flame type again.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

### INDUSTRIAL APPLICABILITY

The present invention is provided with an electric fireplace, with a concealable control panel, the appearance of the electric fireplace is more like traditional firewood fireplace, and the consumers can get a better view of flame, the present invention is simple structural and easy to manufacture.

1. An electric fireplace, comprising a main body, a control panel, a control circuit and a driving mechanism; the main body includes a housing and a simulation device, the simulation device and the control circuit are disposed inside the housing, the simulation device, the control panel, the driving mechanism are respectively electrically connected to the control circuit; the control panel is pivot joint to an edge of the front wall of the housing; the driving mechanism is connected to the control panel to make the control panel with an unfold state and a fold state with respect to the main body.

2. An electric fireplace according to claim 1, wherein the driving mechanism includes a motor and a rotation shaft connected to the motor, the control panel is secured to the rotation shaft.

3. An electric fireplace according to claim 2, wherein the control circuit includes a single chip and a control button, an output of the single chip is connected to the motor.

4. An electric fireplace according to claim 3, wherein further comprising a glass cover, the glass cover is covered on the front wall of the housing; the control panel is disposed with several touch switches.

5. An electric fireplace according to claim 4, wherein the control panel further includes a displayer to indicate temperature, air pressure or time.

6. An electric fireplace according to claim 4, wherein the driving mechanism further includes two limit switches, two limit switches are respectively disposed in the front side and the rear side of the control panel.

7. An electric fireplace according to claim 4, wherein the housing further includes a baffle, the housing is divided into an upper components area and a lower fire simulation area, the simulation device is placed inside the fire simulation area, the single chip of the control circuit is assembled inside the upper components area or the simulation device.

8. An electric fireplace according to claim 7, wherein two assembly racks are disposed in both sides of the upper portion of the control panel, the assembly portion of the assembly rack is disposed on the bottom surface of the baffle; a groove is disposed at the center of the front of the baffle to assemble the control panel.
